(19) United States
(12) Patent Application Publication
(10) Pub. No.: US 2021/0129698 A1
(43) Pub. Date: May 6, 2021

(54) CHARGING VEHICLE AND METHOD FOR CHARGING AN ELECTRIC VEHICLE

(71) Applicant: ZF Friedrichshafen AG, Friedrichshafen (DE)

(72) Inventors: Marc SCHIEß, Hohenfels (DE); Andreas KNOLL, Ravensburg (DE); Jens HEIMANN, Stetten (DE); Nils MÜHL, Friedrichshafen (DE)

(21) Appl. No.: 16/640,916

(22) PCT Filed: Jul. 20, 2018
(86) PCT No.: PCT/EP2018/069725

§ 371 Date: Feb. 21, 2020

(30) Foreign Application Priority Data
Aug. 22, 2017 (DE) 10 2017 214 644.3

(51) Int. Cl. B60L 53/39; B60L 53/12; B60L 53/30; B60L 53/60; H02J 50/10; H02J 50/90; H02J 7/00

(52) U.S. Cl. CPC B60L 53/39; B60L 53/12; B60L 53/305; H02J 2310/48; H02J 50/10; H02J 50/90; H02J 7/0047; B60L 53/60

(57) ABSTRACT

A charging vehicle (1) for charging an electric vehicle (2) has a charging system (3), a charging regulator (4), a control device (5) and a contact system (6). The charging system (3) is connected to the charging regulator (4) and the contact system (6). The contact system (6) serves to supply the charging vehicle (1) with electric energy. The charging system (3) is a contactless charging system (3). The charging vehicle (1) can be controlled by the control device (5) in a longitudinal direction and a transverse direction and can be positioned, by the control device (5), into a charging position (7).

This application is a National Stage completion of PCT/EP2018/069725 filed Jul. 20, 2018, which claims priority from German patent application serial no. 10 2017 214 644.3 filed Aug. 22, 2017.

### FIELD OF THE INVENTION

The present invention concerns a charging vehicle for charging an electric vehicle, and a method for charging an electric vehicle.

### BACKGROUND OF THE INVENTION

Vehicles, which drive purely electrically, are becoming more and more popular. The batteries of these vehicles have to be charged which takes some time. To do this, the electric vehicle is connected with a charging station. As soon as the electric vehicle is fully charged, the vehicle can leave the charging station. This is usually not often the case as it, for instance, remains connected overnight. Thus, the charging station is blocked for other electric vehicles.

Through DE 10 2013 207 906 A1, a device is known in which a vehicle is positioned over a primary coil for the inductive charging of a chargeable battery of the vehicle. The vehicle is guided by means of cameras and a control device in such a way that it stops above the primary coil for the inductive charging.

Known from U.S. Pat. No. 9,660,487 B1 is in automatically positioning, wireless energy transfer system for a wireless charging of energy into an object, for instance a vehicle.

Known from DE 20 2017 001640 U1 is an automatic and ground-level charging module for inductive charging of a vehicle-side energy storage device.

Known from US2017/001 527 A1 is a system for wireless charging for an electrically operating vehicle.

### SUMMARY OF THE INVENTION

Starting with the state-of-the-art, the objective of the present invention is to propose an improved possibility for the charging of an electric vehicle. The electric vehicle should be able to be charged regardless of its parking position.

The present invention, based on the above mentioned objective, proposes a charging vehicle for charging of an electric vehicle with the characteristics in accordance with the independent claim(s) and a method for the charging an electric vehicle with the characteristics in accordance with the independent claim(s). Additional, advantageous embodiments and further designs emerge from the dependent claims.

A charging vehicle for charging an electric vehicle has a charging system, a charging regulator, a control device, and a contact system. The charging system is connected to the charging regulator and the contact system, the contact system serves to supply of the charging system with electrical energy. The charging system is a contactless charging system, The charging vehicle can be controlled by means of the control device in a longitudinal direction and transversal direction and can be positioned by the control device at a charging position. The electric vehicle is for instance a PKW (passenger car), NKW (truck), E-scooter, E-Motor Bike, or E-Bike.

The charging vehicle is dimensioned in a way and designed such that it can drive underneath an electric vehicle. In other words, the charging vehicle is designed to be very low. The height of the parking vehicle should therefore not exceed a maximum dimension of approximately 110 mm. The charging vehicle can have, for instance, three or more wheels or a chain drive for moving along. The charging vehicle is electrically driven and has for this purpose an electrical drive train. It can be, for instance, designed by means of wheel-individual electric motors, i.e. by means of hub motors. The charging system of the charging vehicle has a storage for the electric energy, for instance one or more batteries. This charging system is designed such that it can execute a contactless charging of the electric vehicle. Hereby, the charging system has, as an example, an induction coil by which the electric vehicle is charged without contact.

The charging regulator of the charging vehicle is connected with the charging system. Hereby, the charging regulator monitors the charging state of the charging system, meaning how much energy is present in the electric energy storage. The charging regulator controls how much energy is supplied by the energy storage of the charging system and how much energy is stored in it. In addition, the charging regulator monitors the charging condition of the electric vehicle while it is charged by means of the charging vehicle. The charging regulator can be wirelessly connected or hard wired to the control device.

The contact system is also connected to the charging system. The contact system serves for supplying the charging vehicle with electric energy. The contact system can, for instance, be a plug system via which the charging vehicle can be connected with a power outlet. This plug system can be designed such that it connects itself automatically with an electrical energy supply, or more precisely, with a power outlet. By means of the contact system, electrical energy is therefore supplied to the charging system of the charging vehicle, wherein the supply of energy is controlled by the charging regulator. The contact system can, for instance, be connected to the control device in a wireless or wired manner and can be controlled by the control device in order to connect to a power outlet when the charging vehicle is positioned in the charging position. Alternatively, the contact system can automatically connect to the socket when the charging vehicle is positioned in the charging position.

The control device of the charging vehicle serves a control the vehicle in a longitudinal direction and in a transverse direction. The longitudinal direction is the direction which is defined by the longitudinal axis of the charging vehicle. The transverse direction is the direction which is defined by a transverse axis of the charging vehicle. In other words, the vehicle can travel in different directions on a drive surface. Thus, the control device controls the wheels or the chain drive of the charging vehicle and can align them, for example, adjust the steering angle. In addition, the control device can control acceleration of the charging vehicle and can activate the electric drive of the charging vehicle. In other words, the control device is designed in such a way that it can drive the charging vehicle automatically or autonomously.

Autonomous driving means that the parking vehicle executes its own route, for example, perceives and monitors its surroundings using sensors and determines its route based on the sensor data. Automated driving, to the contrary, is comparable with remote controlled driving. Herein, the parking vehicle receives by means of its communication device, for instance from a central device, a predetermined drive route and travels along this route. In addition, the central device can transmit control signals to the parking vehicle and control the control device of the parking vehicle.

The charging vehicle can be positioned at the charging position by means of the control device. The charging vehicle can thus be controlled in such a way that it is moved to the charging position and stopped at the charging position. The charging position is the particular position below the electric vehicle at which a contactless, i.e., inductive charging procedure takes place or can take place. In other words, the charging system is positioned in such a way below the battery of the electric vehicle so that the battery of the electric vehicle can be charged without contact. Wherein the electric vehicle resides in a stationary position and is preferably parked. For example, the electric vehicle can be located in a parking lot or a parking garage and be parked there.

The charging process will be monitored by means of the charging regulator. As soon as it recognizes that the charging process is completed, the charging vehicle can be moved away. Hereby, the control device moves the charging vehicle away from the charging position. Alternatively, the electric vehicle can also provide a signal that the charging process is completed. Again, the control device can then move the charging vehicle away from the charging station. The charging process is completed at the time when the battery of the electric vehicle has reached a predetermined charge state. This charge state can, for instance, correspond to a completely charged or partially charged battery. For example, the battery can only be charged to ¾, to ⅔, to ½ or similar.

It is advantageous that the charging vehicle, for contactless charging, can be used for different electric vehicles. As soon as the charging process of an electric vehicle is completed, the charging vehicle is moved away from the charging position of this electric vehicle to another electric vehicle that still has to be charged, and is positioned there at the charging position of this further electric vehicle. As a result, an electric vehicle to be charged does not remain connected to a charging station for an unnecessarily long time, since the charging vehicle is a moving charging station. This prevents the charging station from being blocked by an already charged electric vehicle.

It is also advantageous that the charging vehicle, due to its contactless charging system, does not need to have all the different standard plugs which are currently in use to connect electric vehicles with a charging station for charging. Furthermore, conventional sockets can be used in parking lots or in parking garages, with which the charging vehicle can connect by means of its contact system.

It is also advantageous that the vehicles which need to be charged do not have to have their own intelligence in order to move themselves towards the charging station and to move away from the charging station after the charging process is completed. As a result, the manufacturing costs of electric vehicles can be kept lower than electric vehicles which have their own intelligence.

In one embodiment, the charging vehicle has in addition a communications device for the transmission and reception of data and which is connected with the control device. This communications device serves for the communication of the charging vehicle with external systems, i.e., with the electric vehicle and a central device, for instance a control center, which can be a parking area monitor, or a Cloud. The communications device uses for the communication preferably a broadcast standard. By means of the communications device, an exchange of data can therefore be accomplished between the charging vehicle and the external system. The communications device is connected with the control device. This connection can be wireless or via cables. Through this connection, an exchange of data is possible between the communications device and the control device.

For instance, the central device can transmit positioning data to the charging vehicle, at which location an electric vehicle, which needs to be charged, is present and to which the charging vehicle can move to. Furthermore, the central device can control the charging vehicle remotely by sending data to the control device about how the charging vehicle has to move from its starting position to the electric vehicle to be charged. Hereby, the control device still takes over the control of the charging vehicle in the longitudinal and transverse directions, as well as the acceleration, but the central device takes the route determination. For instance, the central device can transmit control commands to the control device if, for example, it must be driven around a curve.

For instance, the electric vehicle can send data by means of the communication device to the charging vehicle that a charging procedure is to be carried out or that a charging procedure has finished. For example, the charging vehicle can send data to the central device and/or to the electric vehicle that it will execute, carry out, or has completed a charging process. In case there is a malfunction with the charging vehicle, this can also be sent to the central device by means of communication device, for example, send its position data to the central device. This positioning data is determined by means of the position determination device which the charging vehicle can have. This can be for example an indoor navigation system, a navigation system or a GPS system.

In another embodiment, the control device guides the charging vehicle based on the data which was received via the communication device. The communication device receives from the central device, data regarding the electric vehicle which has be charged and regarding the drive route. In other words the charging vehicle receives position data of the electric vehicle which has to be charged, meaning at which position the electric vehicle, which has to be charged, is located. In addition, the charging vehicle receives drive route data about the drive route along which the charging vehicle has to drive to get to the electric vehicle to be charged and its charging positron. The charging vehicle can send its position data to the central device by means of the communication device.

The control device controls the charging vehicle in the longitudinal and transverse directions along its drive route which is predetermined by the central device, and accelerates the charging vehicle. In other words, navigation of the charging vehicle resides with the central device.

In another embodiment, the charging vehicle has in addition a sensor system that is connected with the control device for the recognition of the surroundings. The sensor system serves for determining the surroundings data of the charging vehicle. The sensor system can for instance be a radar system, a camera system, or a LIDAR system, or a combination of these systems. Of course, the sensor system can also be another sensor system suitable for detecting the surroundings. Surroundings data is data that relates to the immediate vehicle surroundings, for instance obstacles, markers, impassable roads, or the like are recognized. The sensor system is hereby designed similar to a sensor system which is used by an autonomously driving vehicle for detecting its surroundings. The sensor system is connected with the control device either wirelessly or via a cable, so that data can be exchanged between the sensor system and the control device.

The sensor system can either have its own analyzing device in order to analyze the detected surrounding data so that only the analyzed surrounding data are sent to the control device, or the control device can take over the analysis of the detected surrounding data, whereby the sensor system transfers the (raw) data to the control device.

In another embodiment, the control device controls the charging vehicle based on the surrounding data which are detected by the sensor system for recognizing the surroundings. The sensor system recognizes the immediate surroundings of the charging vehicle. It determines where obstacles or bumps are located, if there are road markers, where they are located. In addition, it determines if there are road sections present on the drive route, which are impassable (i.e. stairs, edges, ledges).

If the charging vehicle is now notified, by means of the communication device, about the position of the electric vehicle to be charged, the charging vehicle can orientate itself by means of the sensor system in the area and can determine by itself the drive route to the electric vehicle, which has to be charged, up to the charging position based on the surrounding data which are detected by the sensor system. The charging vehicle can therefore drive automatically or autonomously along the drive route to the electric vehicle which needs to be charged. For instance, the drive route can additionally be predetermined by the central device which has already been described in the previous specification.

In this case, the surrounding data of the sensor system are used by the charging system to drive on this drive route safely and without collision. The charging vehicle can therefore find by itself its drive route or the central device can inform it by means of the communication device and confirm the plausibly by means of the surrounding data of the sensor system.

In another embodiment, the control device is connected to the charging system and controls the charging system. The connection can either be wireless or wired. The control system can for instance activate or deactivate the charging system. If the control system has positioned the charging vehicle at the charging position, the control system can thereafter activate the charging system and can initiate a charging process of the electric vehicle which needs to be charged. In addition the control device can, based on data from the charging regulator, terminate the charging process when the charging regulator is connected to the control device and a signal that a predetermined charging state of the electric vehicle being charged has been reached.

In another embodiment, the charging vehicle is dimensioned such that it can be driven under the electric vehicle to be charged. The charging vehicle therefore has a very low profile, meaning it is designed flat. The dimensions of the height of the charging vehicle can be related to the minimal ground clearance of the electric vehicle. This minimal ground clearance can for instance be approx. 110 mm.

In a method for charging an electric vehicle by means of the charging vehicle, which was already described above in the specification, the charging vehicle is guided by the control device to the charging position based on surrounding data and/or data which is received via the communications device. The charging vehicle drives hereby automatically or autonomously along a drive route. The charging vehicle can either calculate its drive route by itself and hereby base it on detected and analyzed surrounding data, it can receive from the central device by means of the communication device a predetermined drive route, whereby the charging vehicle uses the surrounding, data additionally, to confirm or ensure the drive route. In other words, the charging vehicle drives the electric vehicle to be charged towards the charging position.

The charging vehicle is positioned underneath the electric vehicle to be charged by the control device, based on the surrounding data and/or the receiving data from the communication device. Contactless charging of the battery of the electric vehicle is enabled in the charging position. The charging vehicle establishes, by means of a contact system, the connection to the energy supply and is supplied with electrical energy. The contact system can connect itself to the electric energy supply either automatically or it can be activated by the control device as soon as the charging vehicle is located at the charging position to connect itself to the electric energy supply. When the charging vehicle is connected to the electric energy supply, the energy storage of the charging system, which is connected to the contact system, is charged with the electric energy. This electric energy serves on one hand as the supply to the charging vehicle itself and, on the other hand, to charge the battery of the electric vehicle. The charging state of the charging system is hereby monitored by the charging regulator. This regulates how much energy is passed into the energy storage of the charging system and how much energy is taken from it.

The charging system transfers electric energy into the electric vehicle without contact, for instance by means of induction, and charges it. The charging regulator monitors the charging of the electric vehicle, e.g., the charging state of the electric vehicle is hereby indirectly monitored, based on the amount of energy which has been supplied by the energy storage of the charging system. The charging of the electric vehicle is terminated as soon as it has reached a predetermined charging state. The charging regulator can either terminate charging of the electric vehicle by itself when the predetermined charging state has been reached or it transfers data to the control device that the predetermined charging state of the electric vehicle has been reached and the control device terminates the charging of the electric vehicle. Alternatively, the electric vehicle can inform the charging vehicle by means of the communication device that a predetermined charging state has been reached, and the charging process is terminated.

If the predetermined charging state of the electric vehicle has been reached, the contact between the contact system and the charging vehicle and the electric energy supply is stopped. Thus, the charging vehicle is separated from the electric energy supply. This can, for instance, take place automatically. Finally, the charging vehicle can be guided away from the charging position by means of the control device, based on surrounding data and/or based on data which was received by the communication device. This is done in the same way as the charging position.

The charging vehicle can then move to another electric vehicle whose battery has to be charged. This method offers the same advantages as the charging vehicle.

According to one embodiment, the positioning of the charging vehicle at the charging position is initiated by the control device on the basis of data received by means of the communication device. For example, the electric vehicle to be charged can inform the charging vehicle by means of the communication device that a charging process is to be carried out. Alternatively, the electric vehicle can inform a central device that a charging process shall be executed, whereby the central device forwards this by means of the communication device to the charging vehicle. Again, alternatively, the central device can use the communication device to directly inform the charging vehicle that a charging process is to be carried out on the electric vehicle to be charged. From there, the charging vehicle is started and moved to the charging position.

### BRIEF DESCRIPTION OF THE DRAWINGS

Based on the following drawings, different embodiments and details of the invention are further described. These show:

FIG. 1 a schematic presentation of the charging vehicle which that performs a charging process, in accordance with an embodiment, and

FIG. 2 a schematic presentation of the charging vehicle in accordance with the embodiment as in FIG. 1

### DETAILED DESCRIPTION OF THE PREFERRED EMBODIMENTS

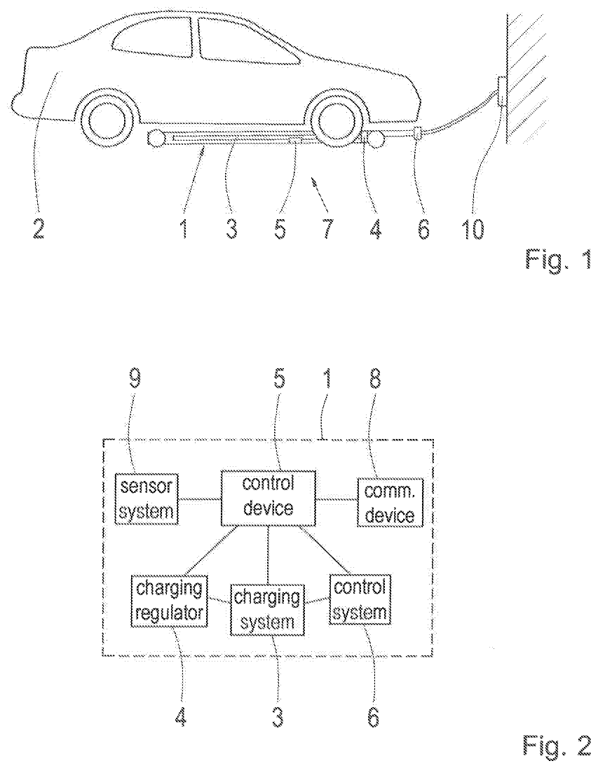

FIG. 1 shows a schematic presentation of the charging vehicle 1, which performs a charging process in accordance with one embodiment. The charging vehicle 1 has a charging system 3, a charging regulator 4, a control device 5, a contact system 6, a sensor system which is not shown here, and a communication device not shown here. The charging system 3 is connected to the contact system 6 and to the charging regulator 4. The control device 5 is connected to the charge controller 4, to the charging system 3, to the contact system 6 and to the communication device and the sensor system. This is shown in more detail in FIG. 2. The charging vehicle 1 also has wheels in order to be able to move along a road surface. In addition the charging vehicle 1 has an electric drive train. This is connected to the charging system 3. The charging vehicle 1 is designed with a low profile, so that it can drive underneath the electric vehicle 2 shown here.

As here presented, the charging vehicle 1 is located at a charging position 7. At this charging position 7, it is possible for the charging vehicle 1 to charge the battery of an electric vehicle 2. For this purpose, the charging system 3 is designed in such a way that it can carry out a contactless charging process of the electric vehicle 2. The charging system 3 thus has an inductive coil.

The charging vehicle 1 is connected to the electric energy supply 10 by means of the contact system 6. This can be for instance a plug-power outlet-system. Hereby, the contact system 6 is for instance designed as a plug which can be connected to a power outlet which can provide electric energy. This connection of the contact system 6 with the electric energy supply 10 can for instance take place fully automatically. As soon as the charging vehicle 1 arrives at the charging position 7 and is positioned there, the contact system 6 automatically connects to the electric energy supply 10. The charging vehicle 1 is supplied with electrical energy via the electric energy supply 10. This energy is temporarily stored in an electric energy storage of the charging system 3. The electric energy serves on one hand to supply the charging vehicle 1 and on the other hand to charge the electric vehicle 2.

The charging regulator 4 monitors the charging of the electric vehicle 2, as well as the charging of the charging system 3. The charging regulator 4 therefore regulates how much energy is passed into the electric energy storage of the charging system 3 and how much energy of this charging system 3 is passed to the electric vehicle 2. The charging regulator 4 thus also monitors a charging state of the battery of the electric vehicle 2. As soon as the charging state of the electric vehicle 2 reaches a predetermined value, which is determined by the charging regulator 4, the charging process of the electric vehicle 2 is terminated.

The control device 5 of the charging vehicle 1 serves to control the charging vehicle 1 in a longitudinal direction and a transversal direction, as well as influence acceleration of the charging vehicle 1. The control device 5 can thus set a steering angle of the wheels of the charging vehicle 1. In addition, the control device 5 can control the contact system 6 in such a way that it establishes disconnects from the electric energy supply 10.

If the electric vehicle 2 shown here needs to be charged by the charging vehicle 1, the charging vehicle 1 is now guided to the charging position 7 by means of the control device 5, based on data of the sensor system or by data of the communications device, and is positioned there. The charging vehicle 1 drives autonomously or automatically. The drive route of the charging vehicle 1 can be predetermined by the central device and transmitted to the control device 5 of the charging vehicle 1 by means of the communication device. As an alternative to this, the charging vehicle 1 can determine its drive route itself by using surroundings data from the sensor system, the surroundings data being transmitted to the control device 5 of the charging vehicle 1. A combination of both options is also possible. As soon as the charging vehicle 1 is positioned at the charging position 7, the control device 5 of the charging vehicle 1 controls the contact system 6 to connects itself to the electric energy supply 10. When this has happened, the control device 5 starts the contactless charging of the electric vehicle 2 by means of the charging system 3. This is monitored by the charging regulator 4. As soon as a predetermined charging state is reached, this being determined by the charging regulator 4, the charging process of the electric vehicle 2 is terminated. The charging vehicle 1 can then be moved away from the charging position 7 and from the electric vehicle 2 by means of the control device 5. The charging vehicle 1 can then be moved to another electric vehicle and can charge it in the same manner.

FIG. 2 shows a schematic presentation of the charging vehicle 1 according to the exemplary embodiment of FIG. 1. Here it is shown again in more detail how the different components of the charging vehicle 1 are connected to one another. The control unit 5 is connected to the sensor system 9, to the communications unit 8, to the charging system 3, to the charging regulator 4, and the contact system 6. In addition, the charging system 3 is connected to the contact system 6 and to the charging regulator 4.

The connection between the control device 5 and the sensor system 9, the communication device 8, the charging regulator 4, the charging system 3, and the contact system 6, can either be wired or wireless. The connection between the contact system 6 and the charging system 3 is wired. More precisely, the contact system 6 is connected to the electric energy storage of the charging system 3. A data exchange takes place between the control device 5, the sensor system 9, the communication device 8, the charging regulator 4, the charging system 3, and the contact system 6. The control device 5 can control all of the systems connected to it.

The charging vehicle 1 shown here and the method shown here can be used, for example, in a parking garage or in a parking lot. In this case, a plurality of electric vehicles 2 can be charged one after another, so that it is not necessary to provide a charging station to which all the electric vehicles 2 can or must connected. The charging vehicle 1 can hereby drive from a charged electric vehicle 2 to the electric vehicles 2 which need to be charged. Thus, the infrastructure within the parking garage or parking lot can be designed with lesser cost. It is also advantageous that the electric vehicle 2 itself does not need have any intelligence to connect itself to a charging station. Obviously, several charging stations 1 can be provided for each parking garage or parking lot, so that several electric vehicles 2 can be charged simultaneously.

The examples presented here are selected only as examples. For instance, a charging vehicle might not have a sensor system, Also, the control device can be connected to fewer systems and can therefore also control fewer systems than shown in FIG. 2.

### REFERENCE CHARACTERS

1 Charging Vehicle
2 Electric Vehicle
3 Charging System
4 Charging Regulator
5 Control Device
6 Contact System
7 Charging Position
8 Communication Device
9 Sensor System
10 Electric Energy Supply

1-9. (canceled)

10. A charging vehicle (1) for charging an electric vehicle (2), the charging vehicle comprising:
a charging system (3),
a charging regulator (4),
a control device (5),
a contact system (6),
the charging system (3) being connected to the charging regulator (4) and the contact system (6),
the contact system (6) supplying the charging vehicle (1) with electric energy,
the charging system (3) being a contactless charging system (3),
the charging vehicle (1) being controllable by the control device (5) in a longitudinal direction and a transverse direction,
the charging vehicle being positionable in a charging position (7) by the control device (5),
the charging vehicle (1) being dimensioned such that the charging vehicle (1) is drivable underneath the electric vehicle (2) to be charged, and
the charging vehicle (1) does not exceed a maximum height of up to 4.33 inches (110 mm).

11. The charging vehicle (1) according to claim 10, further comprising a communication device (8) which transmits and receives data and is connected to the control device (5).

12. The charging vehicle (1) according to claim 11, wherein the control device (5) controls the charging vehicle (1) based on the data received from the communication device (8).

13. The charging vehicle (1) according to claim 11, further comprising a sensor system (9) for detecting surrounding data of the charging vehicle (1), and the sensor system (9) is connected to the control device (5).

14. The charging vehicle (1) according to claim 13, wherein the control device (5) controls the charging vehicle (1) based on the surrounding data detected by the sensor system (9) for detecting surrounding data of the charging vehicle (1).

15. The charging vehicle (1) according to claim 11, wherein the control device (5) is connected to the charging system (3) and controls the charging system (3).

16. A method for charging an electric vehicle (2) by a charging vehicle (1) having a charging system (3), a charging regulator (4), a control device (5) and a contact system (6), the charging system (3) is connected to the charging regulator (4) and the contact system (6), the contact system (6) supplies the charging vehicle (1) with electric energy, the charging system (3) is a contactless charging system (3), the charging vehicle (1) is controllable by the control device (5) in a longitudinal direction and a transverse direction, the charging vehicle is positionable in a charging position (7) by the control device (5), the charging vehicle (1) is dimensioned such that the charging vehicle (1) is drivable underneath the electric vehicle (2) to be charged, and the charging vehicle (1) does not exceed a maximum height of up to 110 mm, the method comprising:
guiding the charging vehicle (1), via the control device (5), towards the charging position (7) based on at least one of surrounding data and data received via the communication device (8);
positioning the charging vehicle (1) with the control device (5) in the charging position (7) underneath the electric vehicle (2) to be charged based on at least one of the surrounding data and the data received via the communication device (8);
establishing, via the contact system (6), a connection between the charging vehicle (1) and an electric energy supply (10) to pass electric energy to the charging vehicle (1);
transferring the electric energy via the charging system (3) into the electric vehicle (2) without contact to charge the electric vehicle (2);
monitoring charging of the electric vehicle (2) with the charging regulator (4);
terminating charging of the electric vehicle (2) when the electric vehicle reaches a certain charging state;
disconnecting, via the contact system (6), the connection between the charging vehicle (1) and the electric energy supply (10) to terminate passage of the electric energy to the charging vehicle (1); and
guiding, via the control device (5), the charging vehicle (1) away from the charging position (7) based on at least one of the surrounding data and the data received via the communication device (8).

17. The method according to claim 16, further comprising initiating, via the control device (5), the positioning of the charging vehicle (1) at the charging position (7) based on the data received via the communication device (8).

18. A charging vehicle for supplying electrical energy to an electric vehicle, the charging vehicle comprises:
a charging system which is directly connected to a charging regulator and a contact system;
the contact system being configured to releasably connect the charging system to an electrical energy supply to supply the charging system with the electrical energy;
a control device for adjusting acceleration of the charging vehicle and controlling longitudinal and transverse movement of the charging vehicle to guide the charging vehicle into and away from a charging position directly below the electric vehicle such that the charging system is connectable to the electrical energy supply, via the contact system, to supply the charging vehicle with the electrical energy when the charging vehicle is positioned in the charging position;
the charging vehicle is dimensioned with a maximum height dimension of 4.33 inches (110 mm) such that, in the charging position, the charging vehicle is vertically spaced by a gap from the electric vehicle; and
the charging system comprises an induction coil such that when the charging vehicle is in the charging position beneath the electric vehicle, the electric energy is passed inductively from the charging system to the electric vehicle across the gap therebetween.
